(19) United States
(12) Patent Application Publication
(10) Pub. No.: US 2016/0109991 A1
(43) Pub. Date: Apr. 21, 2016

(54) TOUCH DETECTION DEVICE

(71) Applicant: CRUCIALTEC CO., LTD., Chungcheongnam-do (KR)

(72) Inventors: Young Jin OH, Gyeonggi-do (KR); Jun Yun KIM, Gyeonggi-do (KR); Jong Bum KIM, Seoul (KR); Ick Chan JEONG, Gyeonggi-do (KR); Byung Chul JEONG, Seoul (KR)

(21) Appl. No.: 14/786,823

(22) PCT Filed: Apr. 25, 2014
(86) PCT No.: PCT/KR2014/003650

§ 371 Date: Oct. 23, 2015

(30) Foreign Application Priority Data
Apr. 29, 2013 (KR) 10-2013-0047259
Apr. 24, 2014 (KR) 10-2014-0049570

(51) Int. Cl. G06F 3/047; G06F 3/041; G06F 3/044

(52) U.S. Cl. CPC G06F 3/047; G06F 3/044; G06F 3/0416

(57) ABSTRACT

According to an embodiment of the present invention, provided is a touch detection device comprising: a plurality of sensor pads disposed to configure a plurality of columns for forming touch capacitance in a relationship with a touch generation means; and a plurality of signal wirings extending from each of the plurality of sensor pads and connected to a touch detection unit which detects touch generation on the basis of output signals from the plurality of sensor pads, wherein at least a part of the plurality of signal wirings extends through the gap between the plurality of sensor pads belonging to the same column.

### TECHNICAL FIELD

The present invention relates, to a touch detection device, more specifically to a touch device where the arrangement of signal wirings from sensor pads is dispersed into several areas so as to form the area of the Dead Zone to be narrower.

### BACKGROUND ART

A touchscreen panel is a device for inputting user command by touching letters or diagrams displayed on the screen of an image display device with a human finger or other touch means, which is used attached to an image display device. The touchscreen panel converts the touch location touched with the human finger, etc. into electrical signals. The electrical signal is used as an input signal.

FIG. 1 is an exploded plan view of an embodiment of the capacitive touchscreen panel according to conventional art.

Referring to FIG. 1, a touchscreen panel 10 includes a transparent substrate 12, and a first sensor pattern layer 13, a first insulating layer 14, a second sensor pattern layer 15, and a second insulating layer 16 formed in order on the transparent substrate 12, and a metal wiring 17.

The first sensor pattern layer 13 may be connected along the lateral direction on the transparent substrate 12, and may be connected with the metal wiring 17 in the unit of rows.

The second sensor pattern layer 15 may be connected along the longitudinal direction on the first insulating layer 14, and disposed alternately with the first sensor pattern layer 13 so as not to overlap with the first sensor pattern layer 13. Also, the second sensor pattern layer 15 is connected with the metal wiring 17 in the unit of columns.

When a human finger or touch means touches the touchscreen panel 10, the change in capacitance according to touch location is delivered to the driving circuit through the first and second sensor pattern layers 13 and 15, and metal wiring 17. Also, the touch location is identified as the change in capacitance delivered as above is converted into an electrical signal.

However, each sensor pattern layer 13 and 15 of the touchscreen panel 10 should have a pattern made of transparent conductive materials such as indium-tin oxide (ITO), separately, and there should be an insulating layer 14 between the sensor pattern layers 13 and 15. Accordingly, the thickness increases.

Also, since touch may be detected only after accumulating the minute changes in capacitance generated by touch several times, the change in capacitance is to be detected with high frequency. Further, in order to accumulate enough change in capacitance within a predetermined time, a metal wiring for maintaining low resistance is required. However. such metal wiring makes the bezel at the edge of the touchscreen thick and causes an additional mask process to occur.

In order to solve this problem, an apparatus for detecting touch was suggested as illustrated in FIG. 2.

The apparatus for detecting touch illustrated in FIG. 2 includes a touch panel 20, a driving device 30, and a circuit board 40 connecting the two.

The touch panel 20 is formed on a substrate 21, and includes a plurality of sensor pads 22 arranged in the form of a polygonal matrix, and a plurality of signal wirings 23 connected with the sensor pad 22.

For each signal wiring 23, one end is connected with a sensor pad 22 and the other end protrudes to the lower edge of the substrate 21. The sensor pad 22 and signal wiring 23 may be patterned on the cover glass 50.

The driving device 30 selects one of the plurality of sensor pads 22 after the other, and measures the capacitance of the corresponding sensor pad 22. Accordingly, it detects whether touch is made.

The signal wiring 23 connects the sensor pad 22 to the driving device 30, and the signal wiring 23 may be patterned by ITO.

FIG. 3 illustrates a plurality of sensor pads 22 arranged in adjacent columns and a signal wiring 23 connected to each of the sensor pads 22 in a touch detection device illustrated in FIG. 2.

Referring to FIG. 3, each sensor pad 22_1 and 22_2 has a rectangular shape and is arranged in a line. Thus, signal wirings 23 extended from each of the sensor pads 22_1 and 22_2 forming one column should be extended through the side of the sensor pads 22_1 and 22_2. That is, signal wirings should be extended through an outermost edge of the sensor pads 22_1 and 22_2 arranged in the form of a matrix, or extended through a space between columns where the sensor pads 22_1 and 22_2 are arranged.

According to this method, the gap between the sensor pads 22_1 and 22_2 arranged in adjacent columns as illustrated in FIG. 3 should be over a gap through which the signal wiring 23 from the sensor pads 22_1 and 22_2 arranged in one column can pass.

For example, assuming that the sensor pads 22_1 and 22_2 are arranged in the form of 7×2 matrix as illustrated in FIG. 3, seven signal wirings 23 for connecting the driving device 30 and each of the sensor pads 22_1 and 22_2 one to one exist between the sensor pad 22_1 in a first column and the sensor pad 22_2 in a second column. Actually, since the sensor pads 22_1 and 22_2 are arranged in several columns, regardless of the form of arranging the signal wiring 23, the same number of signal wiring 23 as the number of sensor pads 22_1 and 22_2 forming one column should be arranged in at least one of spaces between columns. Thus, when arranging the sensor pads 22_1 and 22_2 in, the form of a matrix, the columns should have a gap to the extent that the same number of signal wiring 23 as the number of sensor pads 22_1 and 22_2 forming at least one column may be laid.

A line width of this signal wiring 23 may be formed to be considerably narrow from several micrometers to scores of micrometers. Actually, however, a great number of sensor pads 22_1 and 22_2 are arranged in one column. Thus, in order for the same number of signal wiring 23 as the sensor pads 22_1 and 22_2 to be arranged being separated with a certain gap, a considerable degree of gap should exist between the sensor pad 22_1 in the first column and the sensor pad 22_2 in the second column.

A touch detection operation is made, after selecting one of a plurality of sensor pads 22_1 and 22_2, by a change in an output signal from the sensor pads 22_1 and 22_2 according to capacitance formed between the corresponding sensor pads 22_1 and 22_2 and touch generation means, Thus, for touch generation in an area where the sensor pads 22_1 and 22_2 do not exist, touch detection is impossible.

An area in which touch detection in a corresponding area is impossible due to the absence of sensor pads 22_1 and 22_2 or an area with a relatively inferior sensing performance is called as a Dead Zone. When a gap is formed between the sensor pads 22_1 and 22_2 for the arrangement of signal wiring 23, the corresponding gap becomes a Dead Zone.

Thus, a technology allowing an improvement in preciseness of touch detection by minimizing an area of this Dead Zone is necessary.

### SUMMARY OF INVENTION

The present invention is to solve the above problems of conventional art, and it is a purpose of the present invention to disperse a number of signal wirings arranged between columns of sensor pads in a touch detection device to another area to minimize a Dead Zone formed in an area for the arrangement of signal wiring.

In order to achieve the above purpose, according to an embodiment of the present invention, a touch detection device including a plurality of sensor pads forming touch capacitance in a relationship with a touch generating means and arranged to have a plurality of columns, and a plurality of signal wirings extended from each of the plurality of sensor pads and connected to a touch detection unit detecting touch generation on the basis of an output signal from the plurality of sensor pads, in which at least one part among the plurality of signal wirings is extended only through a gap among the plurality of sensor pads belonging to the same column, is provided.

The plurality of sensor pads are in the shape of a triangle, and a base line may be arranged to be parallel to the column direction.

The plurality of sensor pads with height directions opposing to each other from the base line may be arranged by turns to form one column.

At least one side among sides except the base line of the sensor pads may be parallel to one side among sides except abase line of an adjacent sensor pad.

The signal wiring extended through the gap among the plurality of sensor pads belonging to the same column may be extended to be parallel to the remaining two sides except the base line of the plurality of sensor pads.

At least one side among the sides forming the plurality of sensor pads may be formed in the pattern of a saw blade.

A difference between the number of signal wiring arranged through the gap between the columns and the number of signal wiring extended through the gap between the sensor pads belonging to the same column may be formed to be one or less.

The numbers of the signal, wirings, arranged in the gap between the columns may be the same, and the numbers of signal wirings extended through the gap between the sensor pads belonging to the same column may be the same.

The number of the signal wirings extended through the gap between the sensor pads belonging to the same column may be half the number of sensor pads belonging to the same column or an integer closest to the half value.

The signal wirings connected to the sensor pad adjacent to the touch detection unit may be extended through the gap between the sensor pads belonging to the same column.

According to an embodiment of the present invention, the number of signal wirings arranged between the columns of sensor pads in a touch detection device decreases. Thus, a width of Dead Zone formed in an area for the arrangement of signal wiring is minimized.

According to an embodiment of the present invention, the Dead Zone focused between the columns of the existing sensor pads is dispersed to another area, so that a width of an area which one Dead Zone has may be minimized.

### BRIEF DESCRIPTION OF DRAWINGS

FIG. 1 is an exploded plan view of a conventional touch screen panel;

FIGS. 2 and 3 are views illustrating a configuration of a common touch detection device;

FIGS. 4 and 5 are views illustrating a configuration of a touch detection device according to an embodiment of the present invention; and

FIG. 6 is a view illustrating a configuration of a touch detection device according to another embodiment of the present invention.

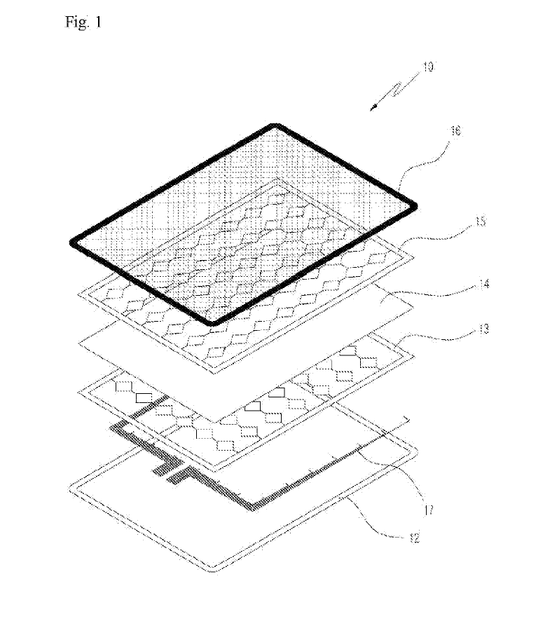

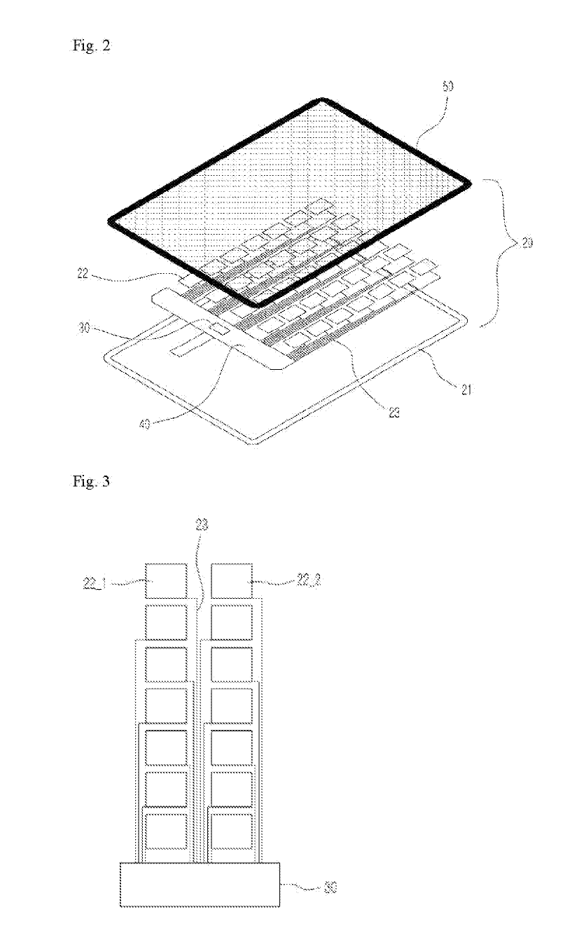

### BEST MODE FOR CARRYING OUT THE INVENTION

Hereinafter, the present invention will be explained with reference to the accompanying drawings. The present invention, however, may be modified in various different ways, and should not be construed as limited to the embodiments set forth herein. Also in order to clearly explain the present disclosure, portions that are not related to the present disclosure are omitted, and like reference numerals are used to refer to like elements throughout.

Throughout the specification, it will be understood that when an element is referred to as being “connected to” another element, it may be “directly connected to” the other element, or intervening elements or layers may be present. In addition, it will also be understood that when a component “includes” an element, unless there is another opposite description thereto, it should be understood that the component does not exclude another element but may further include another element.

Hereinafter, examples of the present invention will be explained in detail with reference to the accompanying drawings.

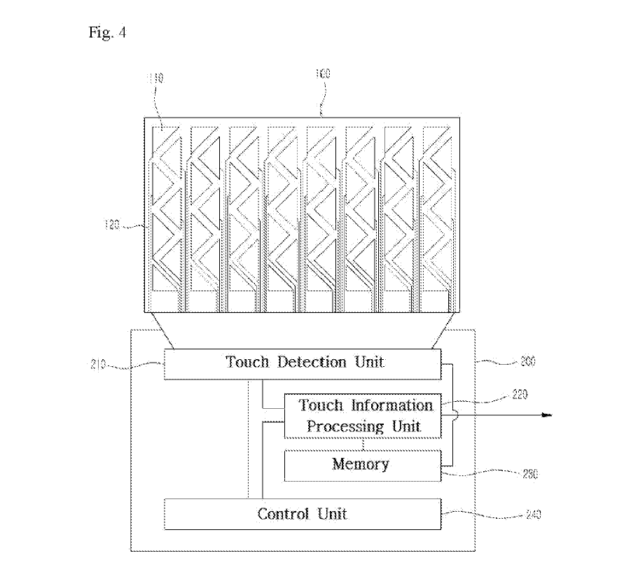

FIG. 4 is a view illustrating a configuration of a touch detection device according to an embodiment of the present invention.

Referring to FIG. 4, the touch detection device according to an embodiment of the present invention includes a touch panel 100 and a driving unit 200.

The touch, panel 100 includes a plurality of sensor pads 110 formed on a substrate and a plurality of signal wirings 120 connected to each of the sensor pads 110. The substrate may be made of glass or a plastic film, etc. of transparent materials.

According to an embodiment of the present invention, the sensor pads 110 may be formed in the shape of a triangle with three lines, and preferably may be formed in the shape of an isosceles triangle where two sides of the triangle have the same length.

The plurality of sensor pads 110 are arranged to have a plurality of columns. The sensor pads belonging to one column are alternately arranged in a column direction, and adjacent sensor pads 110 may be separated with a certain gap. As described above, the sensor pads 110 may be formed in the shape of an isosceles triangle. When referring to the two sides with the same length as its first side and second side, respectively and the remaining other side as a base line, a base line of the sensor pads 110 may be arranged, to be parallel to the column direction. Additionally at least one side among the sides except the base line of the sensor pads 110 may be parallel to one side among the sides except a base line of an adjacent sensor pad 110. Specifically, the first side of a specific sensor pad 110 is formed to be parallel to the second side of an adjacent sensor pad 110. Additionally, when giving numbers from the closest sensor pad 110 to the furthest sensor pad 110 starting from the driving unit 200, even numbered sensor pads 110 are arranged in a reverse direction between odd numbered sensor pads 110. The first and second sides of the odd numbered sensor pads 110 are arranged to be parallel being separated from the first line or the second line of the even numbered sensor pad 110. The signal wiring 120 may be extended through this separated gap. That is, the signal wiring 120 may be arranged in the gap between columns of the sensor pads 110, as well as in the gap between the sensor pads 110 belonging to one column. In the past, an area where the signal wiring 120 may be arranged was limited to a gap between columns. However, according to an embodiment of the present invention, the signal wiring may be arranged in the gap between the sensor pads 110 belonging to one column. Thus, the arrangement of the plurality of signal wirings 120 may be dispersed into several areas, and accordingly, the gap between columns of the sensor pads 110 may be formed to be narrower. An, explanation for this will be made later in detail.

Meanwhile, a line width of the signal wiring 120 may be formed to be considerably narrow from several micrometers to scores of micrometers. The signal wiring 120 may be formed to extend from each of the sensor pads 110 to the driving unit 200.

The sensor pads 110 and signal wiring 120 may be made of transparent conductive materials such as Indium-Tin-Oxide (ITO), Antimony Tin Oxide (ATO), Indium-Zinc-Oxide (IZO), carbon nanotube (CNT), graphene, etc.

The sensor pads 110 and signal wiring 120 may be formed at the same time by for example, laminating an ITO film on a substrate using a method like sputtering, etc. and patterning the ITO film using an etching method like a photolithography, etc. A transparent film may be used as the substrate.

Meanwhile, the sensor pads 110 and signal wiring 120 may be directly patterned on a cover glass. In this case, the cover glass, sensor pads 110 and signal wiring 120 are implemented integrally, so the substrate may be omitted.

The driving unit 200 for driving the touch panel 100 may be formed on a circuit substrate such as a print circuit substrate or a flexibility circuit film. However, the driving unit is not limited thereto, and may be directly mounted on the substrate or a part of the cover glass.

The driving unit 200 may include a touch detection unit 210, a touch information processing unit 220, a memory 230, a control unit 240, etc., and may be implemented with at least one integrated circuit (IC) chip, The touch detection unit 210, touch information processing unit 220, memory 230 and control unit 240 may be implemented being separate from each other, or may be implemented having at least two of the components integrated.

The touch detection unit 210 may include a plurality of switches connected to the signal wiring 120, a plurality of capacitors and a plurality of impedance elements. For touch detection, the touch detection unit may further include a multiplexer for selecting the sensor pads 110. According to an embodiment of the present invention, the touch detection unit 210 selects a specific sensor pad 110 through the multiplexer, and detects whether touch is made through a signal outputted from the corresponding sensor pad 110. The sensor pad 110 forms touch capacitance in a relationship with a touch generation means. Since signals outputted according to capacitance are different, it may be detected whether a touch is made for the corresponding sensor pad 110 through the output signal detection. This touch detecting unit 210 receives a signal from the control unit 240 to drive circuits for detecting touch, and outputs voltage corresponding to touch detection result. Also, the touch detecting unit 210 may include an amplifier and an analogue-digital converter, converting, amplifying or digitizing the difference in output signal of the sensor pad 110, to store it in the memory 230.

The touch information processing unit 220 processes a digital voltage stored in the memory 230, and creates necessary information such as information on whether a touch is made, touch area and touch coordinates, etc.

The control unit 240 controls the touch detecting unit 210 and touch information processing unit 220, and may include a micro control unit (MCU) and perform predetermined signal processing through firmware.

The memory 230 stores a digital voltage based on the difference in voltage change detected from the touch detection unit 210, and stores predetermined data or real-time data used for detecting touch, calculating area, and calculating touch coordinates.

Hereinafter, the arrangement form of the sensor pads 110 and signal wiring 120 illustrated in FIG. 4 will be explained in detail.

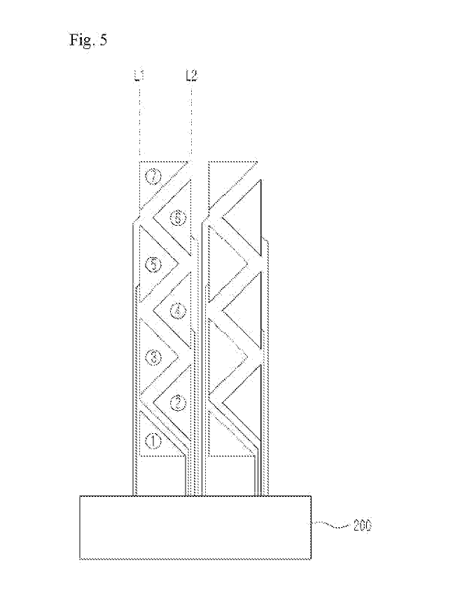

FIG. 5 is a view illustrating in detail a configuration of the sensor pads 110 and signal wiring 120 according to an embodiment of the present invention.

Referring to FIG. 5, for the sake of explanation, it is assumed that the sensor pads 110 are arranged with two columns and one column consists of seven sensor pads 110. Additionally, in each column, numbers \textcircled{1} to \textcircled{7} are given to the sensor pads 110 from the closest one from the driving unit 200.

Each sensor pad 110 may be formed in the shape of a triangle, preferably, an isosceles triangle.

Among the sensor pads 110 belonging to one column, base lines of odd numbered sensor pads \textcircled{1}, \textcircled{3}, \textcircled{5} and \textcircled{7} form a first straight line L1, and base lines of even numbered sensor pads \textcircled{2}, \textcircled{4} and \textcircled{6} form a second straight line L2 which is different from the first straight line. The first straight line L1 and the second straight line L2 may be parallel to the column direction in which the sensor pads 110 are arranged.

In one column, each of the even numbered sensor pads \textcircled{2}, \textcircled{4} and \textcircled{6} are arranged in a reverse direction between each of the odd numbered sensor pads \textcircled{1}, \textcircled{3}, \textcircled{5} and \textcircled{7}, and each of the odd numbered sensor, pads \textcircled{1}, \textcircled{3}, \textcircled{5} and \textcircled{7} are arranged in a reverse direction between each of the even numbered sensor pads \textcircled{2}, \textcircled{4} and \textcircled{6}. Being arranged in a reverse direction means that height directions are opposing to each other when assuming that the base line is a starting point. That is, the height direction from the base line of the odd numbered sensor pads \textcircled{1}, \textcircled{3}, \textcircled{5} and \textcircled{7} is opposing to the height direction from the base line of the even numbered sensor pads \textcircled{2}, \textcircled{4} and \textcircled{6}. In other words, a plurality of sensor pads whose height directions are opposing to each other from the base line are arranged by turns from the driving unit 200 to form one column.

Accordingly, the remaining two sides except the base line in each of the odd numbered sensor pads \textcircled{1}, \textcircled{3}, \textcircled{5} and \textcircled{7} are arranged to be parallel being separated from at least one side among the remaining two sides except the base line of the even numbered sensor pads \textcircled{2}, \textcircled{4} and \textcircled{6}. For example, a first line B1 between the remaining two sides except the base line of the third sensor pad \textcircled{3} is arranged to be parallel being separated from any one line B1′ of the second sensor pad \textcircled{2}, and a second line B2 is arranged to be parallel being separated from any one line B2′ of the fourth sensor pad \textcircled{4}.

When there are two lines arranged to be parallel being separated from each other, a gap between the two lines may be utilized as an extension passage of the signal wiring 120 as illustrated in the drawings. Accordingly, there are three areas in which the signal wiring 120 extended from the plurality of sensor pads 110 arranged in one column may be arranged. Specifically, the signal wiring 120 may be arranged in an area between each of the sensor pads 110 in a corresponding row in addition to both sides of areas of the corresponding column. In FIG. 5 it is illustrated that the signal wiring 120 from the first sensor pad \textcircled{1}, the third sensor pad \textcircled{3} and a total of three sensor pads among the sensor pads 110 belonging to one column is extended through the gap between the sensor pads 110 belonging to one row. Additionally, it is illustrated that he signal wiring 120 from the fifth sensor pad \textcircled{5} and seventh sensor pad \textcircled{7} is arranged at the left side of the column which the corresponding sensor pads \textcircled{5} and \textcircled{7} belong to, and that the signal wiring 120 from the second sensor pad \textcircled{2}, the fourth sensor pad \textcircled{4} and the sixth sensor pad \textcircled{6} is arranged at the right side of the corresponding column. However, an arrangement other than this is also possible. That is, when the signal wiring 120 from the sensor pads 110 belonging to one column is arranged being dispersed into at least three areas, and when at least a part of the signal wiring is extended only through the gap between the plurality of sensor pads 110 belonging to one column, this falls within the category of the present invention.

The signal wiring 120 extended through the gap among the plurality of sensor pads 110 belonging to one column may be extended to be parallel to the remaining two sides except the base line of the plurality of sensor pads 110.

Meanwhile, FIG. 5 exemplifies that an arrangement form of the sensor pads 110 belonging to the first column is the same as the arrangement form of the sensor pads 110 belonging to the second column. However, this may vary. For example, the arrangement form of sensor pads 110 belonging to the first column and the arrangement form of sensor pads 110 belonging to the second column may be formed to be symmetric to each other based on a virtual straight line between the first column and the second column.

Additionally, among the sensor pads 110 belonging to one column, the sensor pads 110 which are the closest to the driving unit 200 and the sensor pads 110 which are furthest from the driving unit 200 may have a truncated form in a direction vertical to the column direction.

According to the embodiment illustrated in FIG. 5, up to two signal wirings 120 are arranged at the left side of the first column, and up to four signal wirings 120 are arranged at the right side of the first column. That is, four signal wirings 120 are arranged in the gap between the first column and the second column. The reason why four signal wirings 120 are arranged between the first column and the second column is that the signal wiring 120 from the two sensor pads 110 among the sensor pads 110 belonging, to the second column adjacent to the first column is extended through the corresponding area. Meanwhile, there are three signal wirings 120 which are extended through the gap among the sensor pads 110 belonging to the first column.

Upon comparing a conventional manner of arranging a signal wiring explained with reference to FIG. 3 with a manner of arranging a signal wiring of the present invention explained with reference to FIG. 5, in the past, seven signal wirings were arranged in the gap between adjacent columns, whereas only four signal wirings are arranged in the gap between adjacent columns according to the present invention.

That is, according to the present invention, the signal wiring extended from the sensor pads is dispersed into multiple areas and arranged compared to the prior art, and thereby the number of signal wiring to be extended through one area decreases. Thus, the one area, for example, the gap between the columns formed by the sensor pads, may be remarkably reduced compared to the prior art, and accordingly, the gap among the sensor pads arranged in adjacent columns is reduced. Thus, a Dead Zone may be minimized.

Meanwhile, when the sensor pads 110 are arranged to form a plurality of rows, it is advantageous for preciseness of touch detection and, linearity etc. to have an even gap between each of the sensor pads 110. Thus, it is preferable to implement both the gap between each column and the gap between each sensor pads in a column to be the same as much as possible. To this end, the number of signal wirings 120 extended among the sensor pads belonging to one column should be the same as the number of signal wirings 120 arranged in the gap between each column as much as possible. That is, it would be preferable for the signal wirings 120 extended from the sensor pads 110 arranged in the touch panel 100 and the gap between each column and the gap among the sensor pads 110 in the same column to be equally diverged as much as possible.

In the embodiment illustrated in FIG. 5, seven signal wirings 120 extended from seven sensor pads 110 arranged in one column are diverged into two signal wirings at the left side of the corresponding column, three signal wirings in the gap among the sensor pads 110 in the corresponding column, and three signal wirings at the right side of the corresponding column. Accordingly, four signal wirings 120 are evenly arranged in the gap of each column, and three signal wirings 120 are arranged through the gap among the sensor pads 110 forming one column. That is, two signal wirings 120 are arranged at a very left side and a very right side of the touch panel each However, except for this the number of signal wirings 120 arranged in the gap of each column and the number of signal wirings 120 arranged among the sensor pads 110 belonging to one column are four and three, respectively, i.e., which are implemented to be the same as much as possible.

When the number of sensor pads 110 belonging to one column is an even number, the number of signal wirings arranged in the gap of each column may be the same as the number of signal wirings 120 arranged in the gap among the sensor pads 110 in one column. For example, assuming that eight sensor pads 110 are arranged in one column, when two signal wirings 120 are arranged in the left side of the corresponding column, four signal wirings 120 are arranged in the gap among the sensor pads 110 in the corresponding column, and two signal wirings 120 are arranged at the right side of the corresponding column, the number of signal wirings 120 arranged in the gap of each column may be the same as the number of signal wirings 120 arranged among the sensor pads 110 belonging to one _{column,} which is four.

To generalize this, the number of signal wirings arranged in the gap between columns and the number of signal wirings extended through the gap among the sensor pads belonging to the same column may be the same, or may be, different by one. That is, the difference may be one or less.

Additionally, the number of signal wirings extended through the gap among the sensor pads belonging to the same column may be half the number of sensor pads belonging, to the same column or an integer closest to said half value. For example, when there are nine sensor pads belonging to the same row, the number of signal wirings extended through the gap among the sensor pads belonging to the same column may be four or five. When four signal wirings are formed, the number of signal wirings extended through the left side and right side of each column may be two and three, respectively, or vice versa. Meanwhile, when five signal wirings are formed, the number of signal wirings extended through the left side and right side of gap in each column may be two.

Meanwhile, the numbers of signal wirings arranged in the gap of each column may be the same, but may have a difference by one. The numbers of signal wirings extended through the gap among the sensor pads belonging to the same column are the same or may have a difference by one.

By arranging the signal wirings in this manner, the number of signal wirings arranged in each area may be the same as much as possible, and accordingly, the gap among the sensor pads 110 may be even, and may be minimized.

Meanwhile, in terms of sensor pads 110 belonging to each column, it is preferable to arrange the signal wiring 120 extended from the sensor pad 110 adjacent to the driving unit 200 in an area between the sensor pads 110 in the corresponding column. Resistance of the signal wiring 120 is proportional to a length extended. Thus, by extending the signal wiring 120 connected to the sensor pad 110 which is relatively remote from the driving unit 200 in a straight line from the left side or right side of the corresponding column, and by allowing the signal wiring 120 connected to the sensor pad 110 adjacent to the driving unit 200 to be curved and extended in an area among the sensor pads 110 of the corresponding column, a resistance value of each signal wiring 120 connected to each sensor pad 110 may be implemented to be relatively even. However, an area in which each of the signal wirings 120 is extended may be specified in various ways according to design.

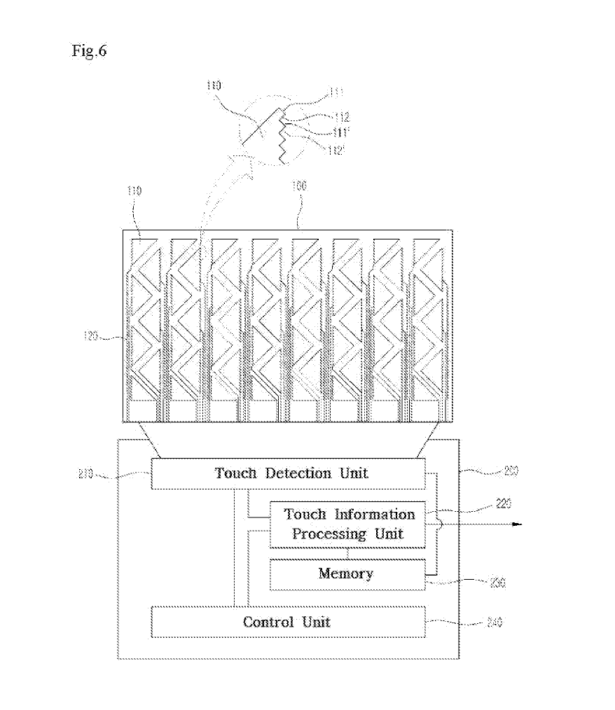

FIG. 6 is a view illustrating a configuration of the touch detection device according to another embodiment of the present invention.

Referring to FIG. 6, the sensor pads 110 are in the shape of a triangle, but at least one side among the three sides may consist of at least one, segment which forms a certain angle based on an extension line of the corresponding side.

For example, one side of the sensor pads 110 may include a convex part in which a first segment 111 and a second segment having different angles based on one side are folded and protruded outwardly or a concave part forming a concave shape inwardly of the sensor pad 110.

At least one side of the sensor pads 110 continuously repeats bending so that the convex part and the concave part may be formed by turns. That is, at least a part of the sensor pads 110 may have a shape of a saw blade.

For example, when the first segment 111 and second segment 112 are folded and bent, the convex part may be formed outwardly of the sensor pad 110. Additionally, when the first segment 111′ and the second segment 112′ are folded and bent, the concave part with a concave shape may be formed inwardly of the sensor pad 110. A shape, a gap, etc. of the convex part and concave part may be modified and applied in various embodiments. At least one side of the sensor pads 110 is formed in the shape of a saw blade, and accordingly, the signal wiring 120 extended adjacent to the side may be extended repeating bending in the shape of a saw blade.

The touch panel may be laminated on a display device or may be built-in. The display device may include a backlight, a polarizing plate, a substrate, a liquid crystal layer, a pixel layer, etc. The pixel layer means a color filter formed on a surface (a top surface or a bottom surface) of the liquid crystal layer for displaying a pixel. Colors may be implemented in a liquid crystal display with a pixel unit of red, green and blue (hereinafter, referred to as R, G and B).

The pixel layer includes a plurality of pixels including sub-pixels of R, G and B. When the sensor pad 110 and signal wiring 120 in the top touch panel are straightly connected to the driving unit 200. a gap between the sensor pad 110 and signal wiring 120 may vary depending on area For example, the gap between the sensor pad 110 and signal wiring 120 becomes closer in an area close to the driving unit 200, whereas the gap between the sensor pad 110 and the signal wiring 120 becomes distant in an area which is far from the driving unit 200. Due to this deviation, there are problems that scattered reflectivity of light emitted from a backlight varies depending on an area, and a difference in gap between the sensor pad 110 and signal wiring 120 may be stood out from outside. Additionally, as mentioned above, since the gap among the signal wirings 120 differs depending on area, an extent in which each signal wiring 120 overlaps R, G and B subpixels also differs depending on an area. Due to this, each pixel differs from each other in terms of color temperature which, each pixel generates according to light transmittance of the signal wiring 120 overlapped on each pixel, and accordingly, a difference in the sense of color is made. According to the embodiment illustrated in FIG. 6, since directions of R, G and B subpixels differ from extension and bending directions of the signal wiring 120, there would be no great difference in an extent where the signal wiring 120 and R, G and B subpixels overlap with each other according to an area. Thus, differences in color temperature and the sense of color according to the area may be minimized.

Although the exemplary embodiments of the present invention have been disclosed for illustrative purposes, those skilled in the art will appreciate that various modifications, additions and substitutions are possible, without departing from the scope and spirit of the present invention as disclosed in the accompanying claims. Therefore, it should be understood that the forgoing description is by way of example only, and is not intended to limit the present invention. For example, each constituent explained in singular form may be carried out being dispersed, and likewise, constituents explained as being dispersed may be carried out in combined forms.

The scope of the present invention is defined by the foregoing claims, and it is intended that the present invention covers the modifications or variations of the present invention provided they come within the scope of the appended claims and their equivalents.

What is claimed is:

1. A touch detection device, comprising:
a plurality of sensor pads forming touch capacity in a relationship with a touch generation means, and arranged to configure a plurality of columns; and
a plurality of signal wirings extended from each of the plurality of sensor pads and connected to a touch detection unit detecting touch generation on the basis of an output signal from the plurality of sensor pads,
wherein at least a part of the plurality of signal wirings extends only through a gap between the plurality of sensor pads belonging to the same column.

2. The touch detection device of claim 1, wherein the plurality of sensor pads are in the shape of a triangle, and a base line is arranged to be parallel to the column direction.

3. The touch detection device of claim 2, wherein the plurality of sensor pads with height directions opposing to each other from the base line are arranged by turns to form one column.

4. The touch detection device of claim 2, wherein at least one side among sides except the base line of the sensor pad is parallel to one side among sides except a base line of an adjacent sensor pad.

5. The touch detection device of claim , wherein the signal wiring extended through the gap among the plurality of sensor pads belonging to the same column is extended to be parallel to the remaining two sides except the base line of the plurality of sensor pads.

6. The touch detection device of claim 2, at least one side among the sides forming the plurality of sensors is formed in the pattern of a saw blade.

7. The touch detection device of claim 1, wherein a difference between the number of signal wirings arranged through the gap between the columns and the number of signal wirings extended through the gap between the sensor pads belonging to the same column is formed to be one or less.

8. The touch detection device of claim 7, wherein the number of signal wirings arranged in the gap between the columns is the same, and the number of the signal wirings extended through the gap between the sensor pads belonging to the same column is the same.

9. The touch detection device of claim 1, wherein the number of signal wirings extended through the gap between the sensor pads belonging to the same column is half the number of sensor pads belonging to the same column or an integer closest to the, half value.

10. The touch detection device of claim 1, wherein the signal wirings connected to the sensor pad adjacent to the touch detection unit is extended through the gap between the sensor pads belonging to the same column.
